(19) United States
(12) Patent Application Publication
(10) Pub. No.: US 2019/0064816 A1
(43) Pub. Date: Feb. 28, 2019

(54) METHOD AND DEVICE FOR PREPARING AND PROVIDING A MAP FOR OPERATING AN AUTOMATED VEHICLE

(71) Applicant: Robert Bosch GmbH, Stuttgart (DE)

(72) Inventor: Mirko Franke, Untergruppenbach (DE)

(21) Appl. No.: 16/109,158

(22) Filed: Aug. 22, 2018

(30) Foreign Application Priority Data
Aug. 24, 2017 (DE) 102017214823.3

(51) Int. Cl. G05D 1/00; G06F 17/30; G01C 21/36

(52) U.S. Cl. CPC G05D 1/0088; G06F 17/30241; G05D 2201/0213; G01C 21/3697; G01C 21/367

(57) ABSTRACT

A method and a device for preparing and providing a map for operating an automated vehicle, including the task of receiving acceleration-data values, which represent accelerations of a vehicle along a route; preparing the map based on an assessment performed according to predefined criteria, the performed assessment being carried out as a function of the acceleration-data values; and providing the map for operating the automated vehicle.

### RELATED APPLICATION INFORMATION

The present application claims priority to and the benefit of German patent application no. 10 2017 214 823.3, which was filed in Germany on Aug. 24, 2017, the disclosure which is incorporated herein by reference.

### FIELD OF THE INVENTION

The present invention relates to a method and a device for preparing and providing a map for operating an automated vehicle, the method having a step of receiving acceleration-data values; a step of preparing the map based on an assessment carried out according to predefined criteria, the performed assessment being carried out as a function of the acceleration-data values; and a step of providing the map for operating the automated vehicle.

### BACKGROUND INFORMATION

Patent document DE 10 2012 016 736 A1 discusses a method for determining a gentle driving route between at least two geographical positions on the basis of cartographical data that reproduce a real road network in the form of route segments and route nodes. The method encompasses a step of providing weightings at least for the route segments, the route segments being allocated at least one first weighting, which indicates a force that occurs and acts on a vehicle or its load when the vehicle is driving along the corresponding route segment; and a step of determining the driving route on the basis of at least the first weighting, the determined driving route representing a route that features low force effects.

Patent document DE 603 03 121 T2 discusses a method for preventing motion sickness, and a device for detecting and signaling movements that may potentially cause motion sickness, which is suitable for use in a method according to the invention.

Patent document DE 10 2013 212 776 A1 discusses a route-planning method and a corresponding device for planning a travel route for a vehicle. In addition, the invention relates to a corresponding computer program and to a corresponding computer-program product for planning a travel route for a vehicle.

### SUMMARY OF THE INVENTION

The method for preparing and providing a map for operating an automated vehicle according to the present invention includes a step of receiving acceleration-data values which represent accelerations of a vehicle along a route; a step of preparing the map, based on an assessment carried out according to predefined criteria, the performed assessment being carried out as a function of the acceleration-data values; and a step of providing the map for operating the automated vehicle.

An automated vehicle is to be understood as a partially, highly or fully automated vehicle.

A vehicle that is subject to accelerations along a route, which are received in the form of acceleration-data values, is any vehicle (automated or non-automated) that is configured to detect the acceleration-data values.

An operator of an automated vehicle, for example, is a driver and/or a passenger (who does not contribute to the operation of the automated vehicle). Within the scope of the present invention, an operator may also represent a plurality of passengers.

A route is to be understood as at least one route section or a plurality of concatenated route sections between a starting and an end point. The route typically corresponds to a driving route between the starting and the end point as it is displayed by a navigation system and/or used for navigation purposes.

A map, for example, is to be understood as data values that represent the map and are available in electronic form in a memory (navigation system, smartphone, server, control unit, etc.) and are used for the navigation and/or for a localization and/or an operation of an automated vehicle.

Accelerations, for example, are longitudinal and/or transverse and/or vertical accelerations, which may occur during travel of the automated vehicle and are therefore acting on the automated vehicle as a force. These forces lead to a rolling motion and/or a pitching motion and/or a vertical motion of the vehicle.

An operator of an (automated) vehicle may often perceive these movements as unpleasant, and/or they may cause illness-like states (nausea, etc.) and/or what is generally referred to as motion sickness (kinetosis). Typically, this is amplified in non-participating operators, as is the case especially with automated vehicles.

In an advantageous manner, it is the object of the present invention to counteract these movements and the related consequences (unpleasant feeling, nausea, motion sickness, etc.) to the maximum extent possible.

The map may be a highly precise map.

A highly precise map is to be understood as a digital map, which is available in the form of (map) data values on a memory medium. The highly precise map, for example, is configured in such a way that one or more map layer(s) is/are encompassed, one map layer, for instance, showing a map from a bird's eye view (extension and position of roads, buildings, landscape features, etc.). This corresponds to a map of a navigation system, for example. Further map layers may include a radar and/or a lidar and/or a video map, for instance. The highly precise map is configured in such a way that it is suitable especially for the navigation of an automated vehicle. For this purpose, the individual map layers at least encompass environmental data including geo positions, for instance, which are known with high precision.

A highly precise position is to be understood as a position that is so precise that it allows for an operation of an automated vehicle as a function of this position. This is to be understood as an inaccuracy in the position of less than 10 cm, for instance.

This offers the advantage that the automated vehicle is able to be localized with the highest precision for the operation, which increases the safety for the automated vehicle and/or the operator during the operation.

The acceleration-data values may be detected using a sensor system of the vehicle.

A sensor system of the vehicle, for example, is to be understood at least as an acceleration sensor. In a further specific embodiment, the sensor system additionally or alternatively includes at least a radar and/or lidar and/or video sensor and/or an ultrasonic sensor, which is/are suitable—in conjunction with a corresponding evaluation unit—to detect the accelerations by detecting the environment of the automated vehicle.

The map may be provided in such a way that the operation of the automated vehicle is carried out at least as a function of the performed assessment.

For example, this offers the advantage that the occurring accelerations are reduced and the related negative effects avoided or reduced because of the performed assessment.

The assessment, which is carried out according to predefined criteria, may be based on an assessment by an operator of the vehicle.

An assessment, for example, is the personal feeling of the operator with regard to the negative effects that accompany the accelerations. For instance, the assessment is performed in that a route section or multiple route sections is/are assessed by assigning the values “very unpleasant”, “unpleasant” and “pleasant” (or corresponding numerical values), the assignments being made with the aid of a suitable input unit.

This offers the advantage that the experienced accelerations are assessed directly by an affected person, which increases the reliability and/or completeness of the map with regard to the negative effects. In addition, for instance, the assessment results in a person-specific selection of the route, which is therefore able to be realized when planning a future route of the particular person.

The device according to the present invention for preparing and providing a map for operating an automated vehicle includes first arrangement for receiving acceleration-data values, which represent accelerations of a vehicle along a route; second arrangement for preparing the map based on an assessment carried out on the basis of predefined criteria, the performed assessment being implemented as a function of the acceleration-data values; and third arrangement for providing the map for operating the automated vehicle.

The first arrangement and/or the second arrangement and/or the third arrangement may be configured to carry out a method as recited in at least one of the method steps.

Advantageous further developments of the present invention are indicated in the dependent claims and mentioned in the description.

Exemplary embodiments of the present invention are shown in the drawing and are described in greater detail in the following descriptions.

### BRIEF DESCRIPTION OF THE DRAWINGS

FIG. 1 shows a first exemplary embodiment of the device according to the present invention.

FIG. 2 shows a second exemplary embodiment of the device according to the present invention.

FIG. 3 shows an exemplary embodiment of the method of the present invention in the form of a flow diagram.

### DETAILED DESCRIPTION

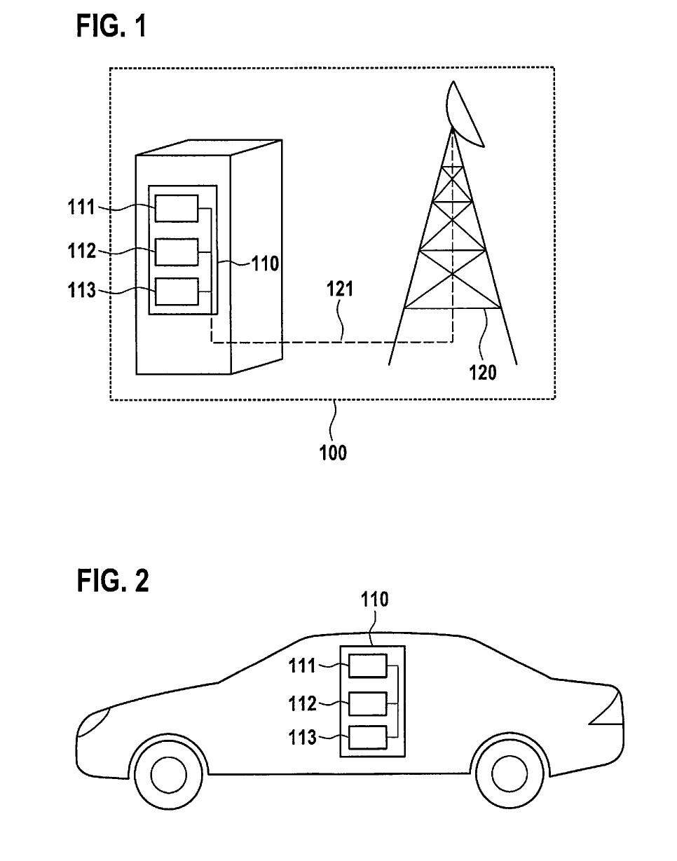

FIG. 1 illustrates a processing unit 100, shown by way of example, which includes a device 110 for preparing 320 and providing 330 a map for operating an automated vehicle. A processing unit 100 may be understood as a server, for example. In another specific embodiment, a processing unit 100 should be understood as a Cloud, i.e. a linkage of at least two electrical data-processing systems, which exchange data with the aid of the Internet, for instance. In another specific embodiment, processing unit 100 corresponds to device 110.

Device 110 includes first arrangement 111 for receiving 310 acceleration-data values, which represent accelerations of a vehicle along a route; second arrangement 112 for preparing 320 the map on the basis of an assessment carried out according to predefined criteria, the performed assessment being carried out as a function of the acceleration-data values; and third arrangement 113 for providing 330 the map for operating the automated vehicle.

First arrangement 111 and/or second arrangement 112 and/or third arrangement 113 may have different developments, depending on the respective specific embodiment of processing unit 100. If processing unit 100 is configured as a server, first arrangement 111 and/or second arrangement 112 and/or third arrangement 113 is/are situated at the same location—in relation to the location of device 110.

If processing unit 100 is configured as a Cloud, first arrangement 111 and/or second arrangement 112 and/or third arrangement 113 may be situated at different locations, e.g., in different cities and/or in different countries, and a connection, such as the Internet, is configured for the exchange of (electronic) data between first arrangement 111 and/or second arrangement 112 and/or third arrangement 113.

First arrangement 111 are configured to receive acceleration-data values, which represent accelerations of a vehicle along a route. For this purpose, first arrangement 111 include a receiver and/or transmitter unit by which data are transmitted. In a further specific embodiment, first arrangement 111 is configured in such a way that it is connected to a transmitter and/or receiver unit 122, situated externally from device 110, with the aid of a cable and/or wireless connection 121. In addition, first arrangement 111 includes electronic data-processing elements, e.g., a processor, a working memory and a hard disk, which are configured to process the acceleration-data values, e.g., to change and/or adapt the data format, and to subsequently forward the data to second arrangement 112.

In addition, the device includes second arrangement 112, which are configured to prepare the map based on an assessment carried out according to predefined criteria, the performed assessment being carried out as a function of the acceleration-data values. Second arrangement 112 include electronic data-processing elements such as a processor, a working memory, a hard disk as well as a corresponding software for this purpose.

An assessment carried out according to predefined criteria, for example, is to be understood in such a way that the acceleration-data values are assessed for each or a plurality of route section(s) along the route. In one specific embodiment, the assessment is a direct assessment in that the acceleration values are subdivided into ranges and each range is characterized accordingly. In a further specific embodiment, the assessment of the accelerations is performed by taking into account curve radii of curves along the route, for example, and/or allowed maximum speeds and/or average speeds and/or the number of traffic lights and/or intersections and/or uphill grades and/or downhill grades and/or differences in altitude, etc. In the process, all values are read in and allocated to an assessment with the aid of a value matrix, for instance.

In a further embodiment, for example, the assessment is performed in that each individual route section and/or a plurality of route sections is assessed by a person or by several persons as a function of the accelerations by carrying out each assessment individually and storing it in second arrangement 112 with the aid of an input by the person or persons.

Subsequently, the assessment, together with the respective associated route section, is prepared as a map. In a further specific embodiment, the map is prepared by expanding an already existing map by the corresponding assessments per route and/or one or more route section(s). The assessment may be carried out, especially as a function of an operator, in such a way that a person-specific driving behavior and/or route planning is afterwards able to be realized again.

In addition, device 110 includes third arrangement 113 for providing 330 the map for operating the automated vehicle. For this purpose, third arrangement 113 include a receiver and/or transmitter unit by which data are able to be requested and/or received.

In a further specific embodiment, third arrangement 113 are configured in such a way that they are connected to a transmitter and/or receiver unit 122, which is situated externally from device 110, the connection being a cable and/or wireless connection 121. In another specific embodiment, the transmitter and/or receiver arrangement are identical to the transmitter and/or receiver arrangement of first arrangement 111.

In addition, third arrangement 113 include electronic data-processing elements, e.g., a processor, a working memory and a hard disk, which are configured to process the map in the form of data values, e.g., to change and/or adapt the data format, and to subsequently provide them in the form of a map.

FIG. 2 shows a vehicle, which includes device 110 for executing method 300. In this exemplary embodiment, the acceleration-data values are received with the aid of first arrangement 111 in that they are detected by a corresponding sensor system of the vehicle and transmitted to first arrangement 111. For example, first arrangement 111 is configured as a control unit for this purpose, which has a processor, a working memory, a hard disk and a corresponding software, for instance. These may be used to process the received acceleration-data values, e.g., to change and/or adapt the data format, and to subsequently forward them to second arrangement 112.

Second arrangement 112, for example, are configured to indicate the accelerations, in particular after the route has been traveled, and have them assessed by at least one operator of the vehicle with the aid of an input device, i.e. a touchscreen and/or keyboard and/or a voice input, etc., and to store the respective assessment, e.g., per one or more route section(s). For this purpose, second arrangement 112 are configured as a control element of the vehicle, for example, and/or linked to a control element in the vehicle, which may be configured also for further functions in the vehicle, for instance. In a further specific embodiment, second arrangement 112 are configured as a transmitter and/or receiver unit or include a transmitter and/or receiver unit, such that the assessment is carried out with the aid of a smartphone (inside the vehicle or outside the vehicle) in that the smartphone exchanges the acceleration-data values and/or the assessments with second arrangement 112.

The assessment together with the individual associated route section is then prepared in the form of a map. In a further specific embodiment, the map is prepared by amending an already existing map by the corresponding assessments per route and/or one or more route section(s).

In addition, device 110 includes third arrangement 113 for providing 330 the map for operating the automated vehicle. For example, third arrangement 113 include a transmitter unit for this purpose with whose aid the map is made available to an external server for operating an automated vehicle. In a further specific embodiment, the vehicle corresponds to an automated vehicle, and the map is provided in such a way that a control unit of the vehicle is able to use the map for the operation, for example.

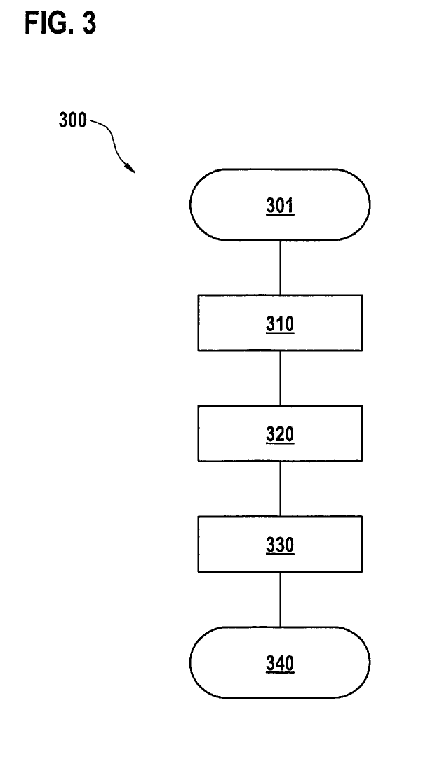

FIG. 3 shows an exemplary embodiment of a method 300 for preparing 320 and providing 330 a map for operating an automated vehicle.

Method 300 starts in step 301.

In step 310, acceleration-data values that represent accelerations of a vehicle along a route are received.

In step 320, the map is prepared based on an assessment that was carried out according to predefined criteria, the performed assessment being carried out as a function of the acceleration-data values.

In step 330, the map is provided for the operation of the automated vehicle.

Method 300 ends in step 340.

What is claimed is:

1. A method for preparing and providing a map for operating an automated vehicle, the method comprising:
receiving acceleration-data values, which represent accelerations of a vehicle along a route;
preparing the map, based on an assessment performed according to predefined criteria, the performed assessment being carried out as a function of the acceleration-data values; and
providing the map for operating the automated vehicle.

2. The method of claim 1, wherein the map is a highly precise map.

3. The method of claim 1, wherein the acceleration-data values are detected with a sensor system of the vehicle.

4. The method of claim 1, wherein the map is provided so that the operation of the automated vehicle takes place at least as a function of the performed assessment.

5. The method of claim 1, wherein the assessment performed according to predefined criteria is based on an assessment by an operator of the vehicle.

6. A device for preparing and providing a map for operating an automated vehicle, comprising:
a receiving arrangement to receive acceleration-data values, which represent accelerations of a vehicle along a route;
a preparing arrangement to prepare the map, based on an assessment carried out according to predefined criteria, the performed assessment being carried out as a function of the acceleration-data values; and
a providing arrangement to provide the map for operating the automated vehicle.

7. The device of claim 6, wherein the map is a highly precise map.

8. The device of claim 6, wherein the acceleration-data values are detected with a sensor system of the vehicle.

9. The device of claim 6, wherein the map is provided so that the operation of the automated vehicle takes place at least as a function of the performed assessment.

10. The device of claim 6, wherein the assessment performed according to predefined criteria is based on an assessment by an operator of the vehicle.
